(19) United States
(12) Patent Application Publication
(10) Pub. No.: US 2026/0188866 A1
(43) Pub. Date: Jul. 2, 2026

(54) METHOD FOR JOINING EXTERNAL TABS OF ANODE ELECTRODES TO A NEGATIVE BATTERY TAB

(71) Applicant: GM GLOBAL TECHNOLOGY OPERATIONS LLC, Detroit, MI (US)

(72) Inventors: Yifan ZHAO, Troy, MI (US); Insun YOON, Shelby Township, MI (US); Sanaz KETABI, Rochester Hills, MI (US); Raneen TAHA, Sterling Heights, MI (US); Hayden CUNNINGHAM, Detroit, MI (US)

(21) Appl. No.: 19/006,446

(22) Filed: Dec. 31, 2024

(51) Int. Cl. H01M 50/536; B23K 20/10; H01M 4/38; H01M 10/0585; H01M 50/105; H01M 50/193; H01M 50/534; H01M 50/54; H01M 50/562

(52) U.S. Cl. CPC H01M 50/536; B23K 20/10; H01M 4/382; H01M 10/0585; H01M 50/105; H01M 50/193; H01M 50/534; H01M 50/54; H01M 50/562

(57) ABSTRACT

A battery cell comprising A anode electrodes, C cathode electrodes, and S separators. The A anode electrodes and the A external tabs include a metal layer including lithium metal forming both an anode active material layer and an anode current collector. The A anode electrodes, the C cathode electrodes, and the S separators are arranged in a predetermined order adjacent to one another, where A, C, and S are integers greater than one. The battery cell includes A external tabs extending from the A anode electrodes, a negative battery tab including nickel, a copper strip arranged around the A external tabs of the A anode electrodes in a direction transverse to a longitudinal direction of the negative battery tab. One end of the negative battery tab is ultrasonically welded to the copper strip and the external tabs of the A anode electrodes.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to a method for joining external tabs of anode electrodes to a negative battery tab.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

Battery cells include cathode electrodes, anode electrodes, and separators. Connections need to be made between positive and negative battery tabs and the cathode electrodes and anode electrodes, respectively, through a battery cell enclosure such as a pouch.

### SUMMARY

A battery cell includes A anode electrodes, C cathode electrodes, and S separators. The A anode electrodes, the C cathode electrodes, and the S separators are arranged in a predetermined order adjacent to one another, where A, C, and S are integers greater than one. A external tabs extend from the A anode electrodes. A metal strip is arranged around the A external tabs of the A anode electrodes and a negative battery tab. One end of the negative battery tab is ultrasonically welded to the metal strip and the external tabs of the A anode electrodes.

In other features, the A anode electrodes and the A external tabs include a lithium metal layer forming both an anode active material layer and an anode current collector. The A anode electrodes and the A external tabs of the A anode electrodes are made of a material selected from a group consisting of lithium-sulfurized polyacrylonitrile (Li-SPAN), lithium-sulfur (Li—S), lithium-nickel manganese cobalt (Li-NMC), lithium-oxygen (Li—O₂), lithium-lithium iron phosphate (Li-LFP), lithium-lithium manganese iron phosphate (Li-LMFP), lithium-nickel cobalt manganese aluminum (Li-NCMA), lithium-lithium and manganese rich (Li-LMR).

In other features, the A anode electrodes and the A external tabs include a sodium metal layer forming both an anode active material layer and an anode current collector. The metal strip is made of a material selected from a group consisting of copper (Cu), titanium (Ti), nickel (Ni), and stainless steel. The metal strip is made of copper. The negative battery tab is made of nickel.

In other features, the metal strip is folded around the A external tabs of the A anode electrodes in a direction transverse to a longitudinal direction of the negative battery tab. A polymer layer surrounds the negative battery tab between opposite ends of the negative battery tab. The polymer layer forms a seal of a pouch enclosure.

A method for joining a negative battery tab to a battery cell includes arranging A anode electrodes, C cathode electrodes, and S separators in a predetermined order adjacent to one another, where A, C, and S are integers greater than one; aligning A external tabs of the A anode electrodes; folding a metal strip around the A external tabs of the A anode electrodes; and ultrasonically welding the external tabs of the A anode electrodes and the metal strip to one end of a negative battery tab.

In other features, the A anode electrodes and the A external tabs include a lithium metal layer forming both an anode active material layer and an anode current collector. The A anode electrodes and the A external tabs of the A anode electrodes are made of a material selected from a group consisting of lithium-sulfurized polyacrylonitrile (Li-SPAN), lithium-sulfur (Li—S), lithium-nickel manganese cobalt (Li-NMC), lithium-oxygen (Li—O₂), lithium-lithium iron phosphate (Li-LFP), lithium-lithium manganese iron phosphate (Li-LMFP), lithium-nickel cobalt manganese aluminum (Li-NCMA), lithium-lithium and manganese rich (Li-LMR).

In other features, the A anode electrodes and the A external tabs include a sodium metal layer forming both an anode active material layer and an anode current collector. The metal strip is made of a material selected from a group consisting of copper (Cu), titanium (Ti), nickel (Ni), and stainless steel. The metal strip is made of copper. The negative battery tab is made of nickel.

In other features, the metal strip is folded around the A external tabs of the A anode electrodes in a direction transverse to a longitudinal direction of the negative battery tab. A polymer layer surrounding the negative battery tab between opposite ends of the negative battery tab.

A battery cell comprising A anode electrodes, C cathode electrodes, and S separators. The A anode electrodes and the A external tabs include a metal layer including lithium metal forming both an anode active material layer and an anode current collector. The A anode electrodes, the C cathode electrodes, and the S separators are arranged in a predetermined order adjacent to one another, where A, C, and S are integers greater than one. The battery cell includes A external tabs extending from the A anode electrodes, a negative battery tab including nickel, a copper strip arranged around the A external tabs of the A anode electrodes in a direction transverse to a longitudinal direction of the negative battery tab. One end of the negative battery tab is ultrasonically welded to the copper strip and the external tabs of the A anode electrodes.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a cross section of a battery cell including C cathode electrodes, A anode electrodes, and S separators according to the present disclosure;

FIG. 2 is a side cross section of A external tabs extending from the A anode electrodes that are spot welded to first and second metal strips in one location and ultrasonically welded to a negative battery tab in a second location;

FIG. 3A is a side cross section of the A external tabs of the A anode electrodes that are ultrasonically welded to a folded metal strip and a negative battery tab at the same location according to the present disclosure;

FIG. 3B is a plan view of the metal strip arranged below the A external tabs of the A anode electrodes prior to folding; and

FIG. 4 is a flowchart of a method for joining a negative battery tab to the A external tabs of the A anode electrodes according to the present disclosure.

In the drawings, reference numbers may be reused to identify similar and/or identical elements.

### DETAILED DESCRIPTION

While the battery cells are described herein in the context of vehicles, the battery cells can be used in other mobile and/or stationary applications.

Cathode electrodes, anode electrodes, and separators of a battery cell are arranged in a predetermined order in a battery cell stack. External tabs of the anode electrodes need to be connected to a negative battery tab that extends through a pouch enclosure. External tabs of the cathode electrodes also need to be connected to a positive battery tab that extends through the pouch enclosure.

The present disclosure relates to a method for joining external tabs extending from free-standing metal (e.g., lithium or sodium) anode electrodes to the negative battery tab. In some battery cells, the anode electrode includes an anode active material layer arranged on one or both sides of an anode current collector. In other battery cells, the anode electrode may include a metal layer (e.g., including lithium (Li), sodium (Na), or alloys) that acts as both an anode active material layer and an anode current collector. In other words, the anode current collector is not needed, which substantially increases the gravimetric energy density of the battery cell.

Connections need to be made between external tabs extending from the lithium metal layers of the battery cell stack and the negative battery tab extending through the pouch. In prior battery cells, opposite sides of the lithium metal layers of the battery cell stack are spot welded in a first location to first ends of first and second copper foil layers, respectively. The first and second copper foil layers are then ultrasonically welded to the battery tab in a second location.

Lithium metal is soft and has a low melting point. When the lithium metal is welded, molten lithium is generated near a welding location. The molten lithium can splash onto other areas of the external tabs of the anode electrode, the negative battery tab, and/or the battery cell (e.g., a pouch cell).

Heat damage can also occur in the joining area. Molten lithium can deposit onto the spot-welded electrodes and/or on the outer surface of the battery cell stack, which is a potential hazard for shorting. In other words, this joining method uses two welded joints, which increases electrical resistance. The increased resistance adversely impacts power and/or high-rate performance of the battery cell.

The present disclosure relates to a method for joining external tabs of free-standing metal anode electrodes to the negative battery tab using a one-step, single-joint ultrasonic weld. As can be appreciated, the need for spot welding is eliminated. The joining method described herein creates a stronger joint (e.g., measured using a pull test) and reduces the risk of splashing molten metal. Furthermore, reducing the number of joints improves the electrical connection by reducing resistance between the anode electrodes and the negative battery tab.

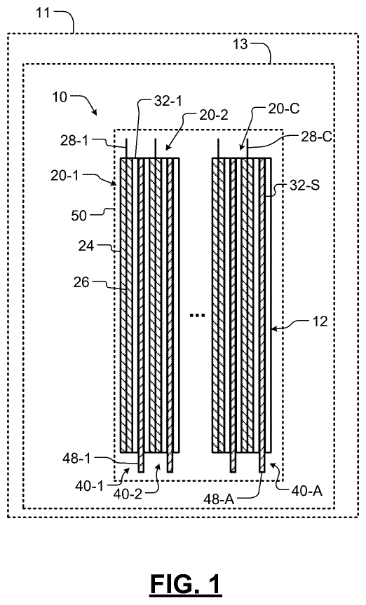

Referring now to FIG. 1, a battery cell 10 includes C cathode electrodes 20, A anode electrodes 40, and S separators 32 arranged in a predetermined order in a battery cell stack 12, where C, S and A are integers greater than zero. In some examples, the vehicle 11 includes a battery module or pack 13 including the battery cell 10. The battery cell stack 12 is arranged in an enclosure 50 such as a pouch enclosure.

The C cathode electrodes 20-1, 20-2, . . . , and 20-C include a cathode active material layer 24 on one or both sides of a cathode current collector 26. The A anode electrodes 40-1, 40-2, . . . , and 40-A include a metal layer (such as lithium metal, sodium metal, and/or alloys) acting as both the anode active material layer and the anode current collector.

During charging/discharging, the A anode electrodes 40 and the C cathode electrodes 20 exchange ions (e.g., lithium ions). In some examples, the cathode active material layers 24 comprise coatings including one or more active materials, one or more conductive additives, and/or one or more binder materials that are applied onto the cathode current collectors 26.

In some examples, the cathode current collectors 26 comprise metal foil, metal mesh, perforated metal, 3 dimensional (3D) metal foam, and/or expanded metal. In some examples, the cathode current collectors 26 comprise aluminum or other suitable materials. External tabs 28-1, 28-2, . . . , and 28-C extend from the cathode current collectors 46 of the C cathode electrodes 20-1, 20-2, . . . , and 20-C. External tabs 48-1, 48-2, . . . , and 48-A extend from the A anode electrodes 40-1, 40-2, . . . , and 40-A, respectively. The external tabs 28-1, 28-2, . . . , and 28-C and the external tabs 48-1, 48-2,. . . , and 48-A can be arranged on the same or different sides of the battery cell stack 12. The external tabs 28 are connected to the positive battery tab and the external tabs 48 are connected to the negative battery tab.

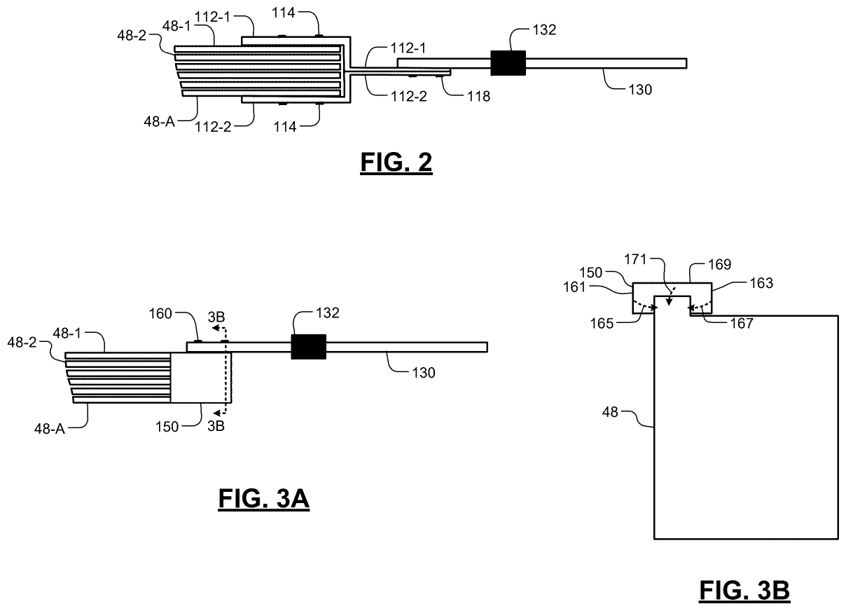

Referring now to FIG. 2, first ends of a first copper strip 112-1 and a second copper strip 112-2 are ultrasonically welded at 118 to a negative battery tab 130 in a first location. The first copper strip 112-1 and the second copper strip 112-2 are arranged on opposite sides of the external tabs 48-1, 48-2, . . . , and 48-A. Second ends of the first copper strip 112-1 and the second copper strip 112-2 spot welded at 114 to the external tabs 48-1, 48-2, . . . , and 48-A in a second location.

In some examples, a polymer layer 132 is arranged between opposite ends of the negative battery tab 130. The polymer layer 132 is arranged on both sides of the negative battery tab 130. The polymer layer 132 is at least partially located in an opening of a pouch enclosure where the negative battery tab 130 exits the pouch enclosure. The pouch enclosure and the polymer layer 132 are heated to seal the pouch enclosure.

As noted above, when the lithium metal is welded, molten lithium is generated near a weld location. The molten lithium can splash onto other areas of the external tabs of the anode electrodes, the negative battery tab, and/or other parts of the battery cell. Heat damage can also occur in the joining area. Molten lithium can deposit onto the spot-welded electrodes and/or on the outer surface of the battery cell stack, which is a potential hazard for shorting. This joining method uses two welded joints, which increases electrical resistance. The increased resistance adversely impacts power and/or high-rate performance of the battery cell.

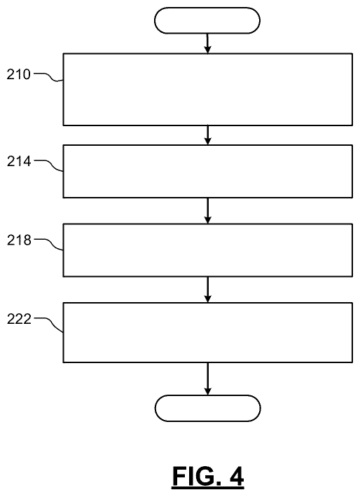

Referring now to FIG. 3A, a joining method according to the present disclosure uses a single ultrasonic weld to join the negative battery tab to the external tabs. A metal strip 150 is arranged/folded around ends of the external tabs 48-1, 48-2, . . . , and 48-A of the A anode electrodes 40-1, 40-2, . . . , and 40-A. An end of the negative battery tab 130 is arranged adjacent to and in contact with the metal strip 150. In some examples, a longitudinal length of the negative battery tab 130 is transverse to a direction that the metal strip is folded around ends of the external tabs 48-1, 48-2, . . . , and 48-A of the A anode electrodes 40-1, 40-2, . . . , and 40-A.

One end of the negative battery tab 130 is ultrasonically welded at a weld location 160 to the metal strip 150 and the external tabs 48-1, 48-2, . . . , and 48-A. The polymer layer 132 is located between the weld location 160 and an opposite end of the negative battery tab 130 as described above.

In some examples, opposite longitudinal ends of the metal strip 150 overlap below the weld location 160 between the negative battery tab 130 and a stack 48 of external tabs 48-1, 48-2, . . . , and 48-A. In some examples, the metal strip 150 is made of a material selected from a group consisting of copper (Cu), titanium (Ti), nickel (Ni), and stainless steel. In some examples, the negative battery tab 130 is made of nickel (Ni).

In FIG. 3B, the metal strip 150 is shown below the stack 48 of external tabs 48-1, 48-2, . . . , and 48-A prior to folding. In some examples, lateral sides 161 and 163 of the metal strip 150 are folded over the stack 48 as shown at 165 and 167. A top side 169 of the metal strip 150 is folded over the lateral sides 161 and 163 of the metal strip 150 and the stack 48 as shown at 171.

In other examples, the top side 169 of the metal strip 150 is initially folded over a top edge of the stack 48 as shown at 171. Then, the lateral sides 161 and 163 of the metal strip 150 are folded inwardly over the top side 169 of the metal strip 150 and the stack 48 as shown at 165 and 167.

As can be appreciated, the tensile strength of the bond increases from around 5 Newtons (N) using the joining method described in FIG. 2 to around 18 N using the joining method in FIG. 3. The joining method in FIG. 3 also requires fewer steps, which reduces cost. The joining method can be used to join tabs of free-standing metal anode electrodes using a single joining step. The joint has increased mechanical strength and improved electrical properties (e.g., reduced resistance due to fewer welds and reduced short circuits due to weld metal splashing).

The joining method can be used to replace the prior joining methods without other changes. The joining method has fewer processing steps (ultrasonic welding only) as compared to the prior approach (spot welding and ultrasonic welding). The joining method improves safety by avoiding metal splashing hazards and quality control by reducing potential contamination hazards. The battery cell does not need anode current collectors, which increases energy density.

While the anode electrodes are described above with lithium metal, other anode active materials such as sodium metal can be used. In some examples, the anode electrode includes a lithium metal layer including one or more materials selected from a group consisting of lithium-sulfurized polyacrylonitrile (Li-SPAN), lithium-sulfur (Li—S), lithium-nickel manganese cobalt (Li-NMC), lithium-oxygen (Li—O₂), lithium-lithium iron phosphate (Li-LFP), lithium-lithium manganese iron phosphate (Li-LMFP), lithium-nickel cobalt manganese aluminum (Li-NCMA), lithium-lithium and manganese rich (Li-LMR), or a blend cathode (including other high-Ni cathode chemistries).

Referring now to FIG. 4, a method for joining a negative battery tab of a battery cell to external tabs of A anode electrodes is shown. At 210, C cathode electrodes, A anode electrodes, and S separators are arranged in a predetermined order in a battery cell stack with external tabs aligned. At 214, a metal strip is wrapped around external tabs of a plurality of anode electrodes. At 218, a negative battery tab is arranged and aligned relative to the metal strip and the external tabs. At 222, the negative battery tab, the metal strip, and the external tabs of the anode electrodes are ultrasonically welded.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

What is claimed is:

1. A battery cell comprising:
A anode electrodes;
C cathode electrodes;
S separators,
wherein the A anode electrodes, the C cathode electrodes, and the S separators are arranged in a predetermined order adjacent to one another, where A, C, and S are integers greater than one;
A external tabs extending from the A anode electrodes;
a metal strip arranged around the A external tabs of the A anode electrodes; and
a negative battery tab,
wherein one end of the negative battery tab is ultrasonically welded to the metal strip and the external tabs of the A anode electrodes.

2. The battery cell of claim 1, wherein the A anode electrodes and the A external tabs include a lithium metal layer forming both an anode active material layer and an anode current collector.

3. The battery cell of claim 1, wherein the A anode electrodes and the A external tabs of the A anode electrodes are made of a material selected from a group consisting of lithium-sulfurized polyacrylonitrile (Li-SPAN), lithium-sulfur (Li—S), lithium-nickel manganese cobalt (Li-NMC), lithium-oxygen (Li—O₂), lithium-lithium iron phosphate (Li-LFP), lithium-lithium manganese iron phosphate (Li-LMFP), lithium-nickel cobalt manganese aluminum (Li-NCMA), lithium-lithium and manganese rich (Li-LMR).

4. The battery cell of claim 1, wherein the A anode electrodes and the A external tabs include a sodium metal layer forming both an anode active material layer and an anode current collector.

5. The battery cell of claim 1, wherein the metal strip is made of a material selected from a group consisting of copper (Cu), titanium (Ti), nickel (Ni), and stainless steel.

6. The battery cell of claim 1, wherein the metal strip is made of copper.

7. The battery cell of claim 1, wherein the negative battery tab is made of nickel.

8. The battery cell of claim 1, wherein the metal strip is folded around the A external tabs of the A anode electrodes in a direction transverse to a longitudinal direction of the negative battery tab.

9. The battery cell of claim 1, further comprising a polymer layer surrounding the negative battery tab between opposite ends of the negative battery tab.

10. The battery cell of claim 9, further comprising a pouch enclosure, wherein the polymer layer forms a seal.

11. A method for joining a negative battery tab to a battery cell, comprising:
arranging A anode electrodes, C cathode electrodes, and S separators in a predetermined order adjacent to one another, where A, C, and S are integers greater than one;
aligning A external tabs of the A anode electrodes;
folding a metal strip around the A external tabs of the A anode electrodes; and
ultrasonically welding the external tabs of the A anode electrodes and the metal strip to one end of a negative battery tab.

12. The method of claim 11, wherein the A anode electrodes and the A external tabs include a lithium metal layer forming both an anode active material layer and an anode current collector.

13. The method of claim 11, wherein the A anode electrodes and the A external tabs of the A anode electrodes are made of a material selected from a group consisting of lithium-sulfurized polyacrylonitrile (Li-SPAN), lithium-sulfur (Li—S), lithium-nickel manganese cobalt (Li-NMC), lithium-oxygen (Li—O₂), lithium-lithium iron phosphate (Li-LFP), lithium-lithium manganese iron phosphate (Li-LMFP), lithium-nickel cobalt manganese aluminum (Li-NCMA), lithium-lithium and manganese rich (Li-LMR).

14. The method of claim 11, wherein the A anode electrodes and the A external tabs include a sodium metal layer forming both an anode active material layer and an anode current collector.

15. The method of claim 11, wherein the metal strip is made of a material selected from a group consisting of copper (Cu), titanium (Ti), nickel (Ni), and stainless steel.

16. The method of claim 11, wherein the metal strip is made of copper.

17. The method of claim 11, wherein the negative battery tab is made of nickel.

18. The method of claim 11, wherein the metal strip is folded around the A external tabs of the A anode electrodes in a direction transverse to a longitudinal direction of the negative battery tab.

19. The method of claim 11, further comprising a polymer layer surrounding the negative battery tab between opposite ends of the negative battery tab.

20. A battery cell comprising:
A anode electrodes;
C cathode electrodes;
S separators,
wherein the A anode electrodes and the A external tabs include a metal layer including lithium metal forming both an anode active material layer and an anode current collector, and
wherein the A anode electrodes, the C cathode electrodes, and the S separators are arranged in a predetermined order adjacent to one another, where A, C, and S are integers greater than one;
A external tabs extending from the A anode electrodes;
a negative battery tab including nickel,
a copper strip arranged around the A external tabs of the A anode electrodes in a direction transverse to a longitudinal direction of the negative battery tab; and
wherein one end of the negative battery tab is ultrasonically welded to the copper strip and the external tabs of the A anode electrodes.
